(19) United States
(12) Patent Application Publication
(10) Pub. No.: US 2019/0034059 A1
(43) Pub. Date: Jan. 31, 2019

(54) Method for sending reminders to users of messaging applications

(71) Applicants: Igaal Brummer, Herzliya (IL); Nir Levy, Herzliya (IL)

(72) Inventors: Igaal Brummer, Herzliya (IL); Nir Levy, Herzliya (IL)

(21) Appl. No.: 15/659,675

(22) Filed: Jul. 26, 2017

(51) Int. Cl. G06F 3/0484; G06F 3/0481; H04L 12/58; G08B 21/24

(52) U.S. Cl. CPC G06F 3/04842; G06F 3/0481; H04L 51/16; G08B 21/24; H04L 51/046

(57) ABSTRACT

A method for sending reminders to users of messaging applications, the method comprising: in a computer, detecting whether a message is marked by the user of a messaging application; when a message is marked by the user of a messaging application, detecting whether the user presses on a designated button; when the user presses on a designated button, requesting the user to set time and date of a reminder; when the user set time and date of the reminder, requesting the user to add a text to the reminder; when the time and date set by the user comes, the reminder, including the marked message and the text added to the reminder, appears in the user interface of the messaging application.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates generally to electronic messaging applications. More specifically, the invention relates to a method for sending reminders to users of electronic messaging applications.

There are many patented inventions for sending reminder messages. For example, U.S. Pat. No. 6,819,256 by Hampton provides for a user device and a corresponding method for providing, dependent on an environment of the user device, a reminder message for a user of the device. U.S. Pat. No. 6,819,256 by Flaherty provides for a personal sensory reminder system including an audio circuit that stores an audio message and which is responsive to a first signal for outputting the audio message. U.S. Pat. No. 5,594,945 by Lewis provides for a method of delivering registration reminder messages in a segmented nationwide or other broad area paging system. U.S. Pat. No. 5,012,219 by Henry provides for a selective call receiver including a message reminder alert controlled by a reminder switch. U.S. Pat. No. 5,012,219 by Danchilla provides for a vehicle message reminder system which includes a timer for closing a timer switch when energized and retaining the switch in closed position for a pre-set time after which the timer coil is de-energized.

The inventions described above do not allow users of messaging applications to set reminders including previously-exchanged text messages. There is a pressing social need for an invention that allow users of messaging applications to set reminders by marking previously-exchanged text messages and clicking on a designated button. The present invention fills the aforementioned gaps in the prior art.

Relevant prior art includes:

U.S. Pat. No. 6,819,256 by Hampton

U.S. Pat. No. 6,819,256 by Flaherty

U.S. Pat. No. 5,594,945 by Lewis

U.S. Pat. No. 5,012,219 by Henry

U.S. Pat. No. 5,012,219 by Danchilla

### SUMMARY OF THE INVENTION

The present invention is a method for sending reminders to users of messaging applications by allowing them to mark previously-exchanged text messages and click on a designated button.

In one embodiment of the invention, the invention is implemented in a messaging application. After being implemented in the messaging application, the invention detects whether a message is marked by the user of the messaging application. If a message is marked by the user of the messaging application, the invention detects whether the user has pressed on a designated button. If the invention detects that the user has pressed on a designated button, the invention allows the user to set time and date of a reminder. After the user sets time and date of the reminder, the user can add a text to the reminder. The reminder, including the marked message and the text added to the reminder, will appear in the user interface of the messaging application at the time and date set by the user.

### BRIEF DESCRIPTION OF THE DRAWINGS

FIG. 1 is a flowchart of an exemplary process of operation of the invention

FIG. 2 is an exemplary user interface of a messaging application

FIG. 3 is an exemplary user interface of a messaging application allowing the user of the invention to set a reminder

FIG. 4 is an exemplary user interface of a messaging application showing a message for which a reminder is set

FIG. 5 is an exemplary user interface of a messaging application showing a reminder

### DRAWINGS—REFERENCE NUMERALS

10—start of the exemplary process of operation of the invention
12—marking a message
14—pressing on a designated button
16—setting time and date of a reminder
18—adding a text to the reminder
20—appearance of the reminder
22—end of the exemplary process of operation of the invention
23—exemplary user interface of a messaging application showing a conversation between two users
24—button “R”
26—exemplary message “User A: Hello”
28—exemplary message “User B: Hello, how are you?”
30—exemplary message “User A: I am fine. Thank you. Please do not forget that we need to discuss our presentation on Friday.”
32—exemplary message: “User B: Sure, I will send an automatic reminder.”
34—exemplary message “User A: Excellent. Thank you.”
36—exemplary message “User B: You are welcome. Bye.”
38—exemplary message “User A: See you.”
40—fillable field containing the message “Type a message here”
41—exemplary user interface allowing the user of the invention to set a reminder
42—title of the exemplary user interface allowing the user of the invention to set a reminder
43—exemplary user interface of a messaging application
47—exemplary user interface of a messaging application showing a reminder
48—fillable field containing the text “Date of Reminder: dd/mm/yyyy”
50—fillable field containing the text “Time of Reminder: hr/min”
52—button “Save”
54—button “Delete”
56—button “Cancel”
58—exemplary notice “Reminder set for 1 Apr. 2018”
60—fillable field “Type a message”
62—exemplary message “User A: Let me know if I can assist you”
64—exemplary message “User B: Sure”
66—exemplary notice “Reminder message”
68—exemplary notice “The presentation relates to the conference”

### DETAILED DESCRIPTION OF THE INVENTION

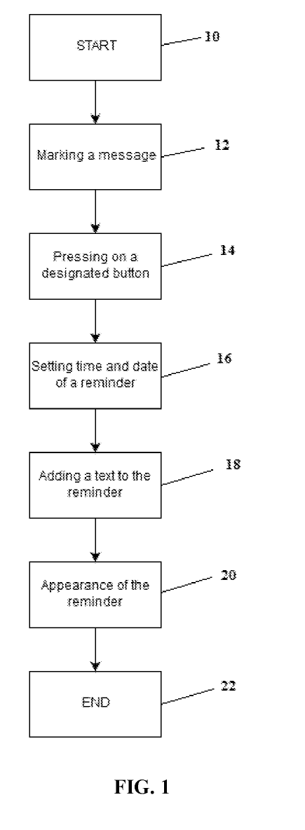

Referring now to the invention in more detail, in FIG. 1 there is shown a flowchart of an exemplary process of operation of the invention consisting of the following steps: start of the exemplary process of operation of the invention 10; marking a message 12; pressing on a designated button 14; setting time and date of a reminder 16; adding a text to the reminder 18; appearance of the reminder 20; and end of the exemplary process of operation of the invention 22.

In more detail, still referring to the invention of FIG. 1, at step 12, the invention detects whether a message in a messaging application is marked. In one embodiment of the invention, a message in a messaging application can be marked by dragging a computer mouse over the message while pressing on one of the buttons of the computer mouse. In another embodiment of the invention, a message in a messaging application which is displayed on a touchscreen can be marked by tapping the message and dragging a finger over it. If the invention detects that a message in a messaging application is marked, step 14 would be initiated. At step 14, the invention detects whether a designated button is pressed. In one embodiment, the designated button may be in the form of a stylized sand clock. In another embodiment, the designated button may be in the form of a stylized bell. If the invention detects that a designated button is pressed, step 16 would be initiated. At step 16, the user of the invention can set time and date of a reminder. After the user sets time and date of a reminder, step 18 would be initiated. At step 18, the user of the invention can add a text to the reminder. After the user of the invention adds a text to the reminder, step 20 would be initiated. At step 20, the reminder set by the user appears on the date and time defined at step 16. In one embodiment of the invention, when the reminder set by the user appears on the date and time defined at step 16, the invention produces a sound signal. In another embodiment of the invention, when the user presses on a designated button, a copy of the message marked by the user will immediately appear in the user interface of the messaging application. In another embodiment of the invention, when the user presses on the reminder, he or she will be immediately referred to the chat history including the marked message.

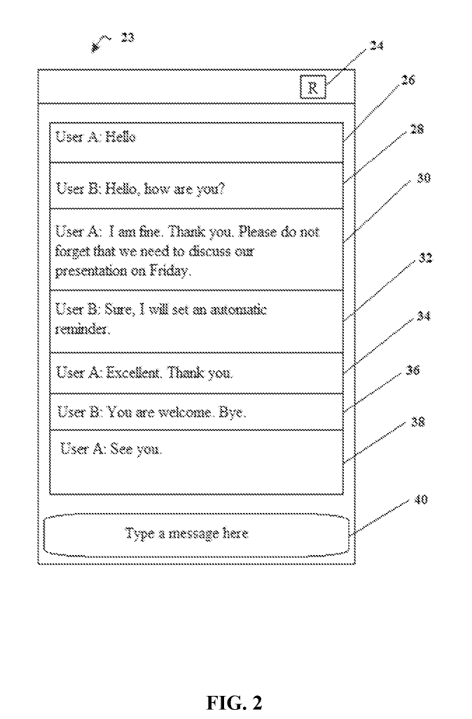

Referring now to the invention in more detail, in FIG. 2 there is shown an exemplary user interface of a messaging application showing a conversation between two users 23. The exemplary user interface of a messaging application showing a conversation between two users 23 includes a button “R” 24, an exemplary message “User A: Hello” 26, an exemplary message “User B: Hello, how are you?” 28, an exemplary message “User A: I am fine. Thank you. Please do not forget that we need to discuss our presentation on Friday.” 30, an exemplary message: “User B: Sure, I will send an automatic reminder.” 32, an exemplary message “User A: Excellent. Thank you.” 34, an exemplary message “User B: You are welcome. Bye.” 36, an exemplary message “User A: See you.” 38, and a fillable field containing the message “Type a message here” 40.

In more detail, still referring to the invention of FIG. 2, the button “R” 24 can be used by the user of the invention to set a reminder. The exemplary message “User A: Hello” 26, the exemplary message “User B: Hello, how are you?” 28, the exemplary message “User A: I am fine. Thank you. Please do not forget that we need to discuss our presentation on Friday.” 30, the exemplary message: “User B: Sure, I will send an automatic reminder.” 32, the exemplary message “User A: Excellent. Thank you.” 34, the exemplary message “User B: You are welcome. Bye.” 36, and the exemplary message “User A: See you.” 38 constitute an exemplary chat conversation between two users of a messaging application, namely, User A and User B. The fillable field containing the message “Type a message here” 40 allows users of a messaging application to type messages.

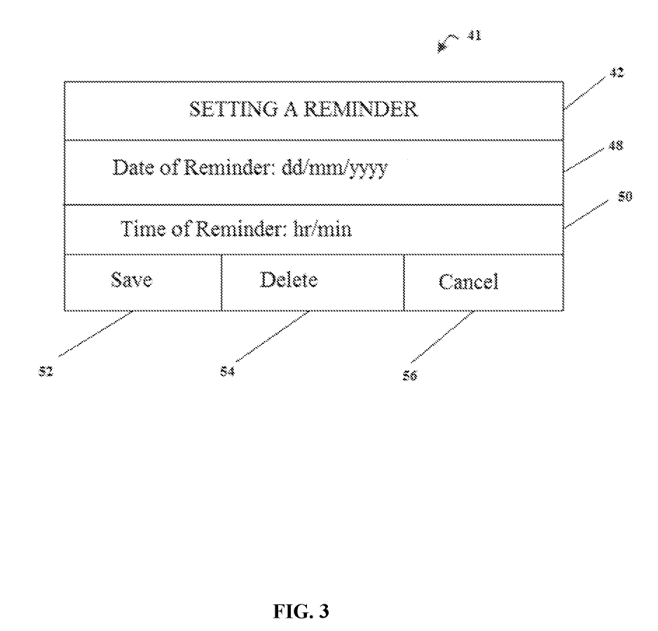

Referring now to the invention in more detail, in FIG. 3 there is shown an exemplary user interface allowing the user of the invention to set a reminder 41. The exemplary user interface allowing the user of the invention to set a reminder 41 includes a title of the exemplary user interface allowing the user of the invention to set a reminder 42, a fillable field containing the text “Date of Reminder: dd/mm/yyyy” 48, a fillable field containing the text “Time of Reminder: hr/min” 50, a button “Save” 52, a button “Delete” 54, and a button “Cancel” 56.

In more detail, still referring to the invention of FIG. 3, the title of the exemplary user interface allowing the user of the invention to set a reminder 42 contains the text “setting a reminder”. The fillable field containing the text “Date of Reminder: dd/mm/yyyy” 48 allows the user of the invention to enter the date of the reminder. The fillable field containing the text “Time of Reminder: hr/min” 50 allows the user of the invention to enter the time of the reminder. The button “Save” 52 allows the user of the invention to save the date inserted in the fillable field containing the text “Date of Reminder: dd/mm/yyyy” 48 and the time inserted in the fillable field containing the text “Time of Reminder: hr/min” 50. The button “Delete” 54 allows the user of the invention to delete the date inserted in the fillable field containing the text “Date of Reminder: dd/mm/yyyy” 48 and the time inserted in the fillable field containing the text “Time of Reminder: hr/min” 50. The button “Cancel” 56 allows the user of the invention to close the exemplary user interface allowing the user of the invention to set a reminder 41. In one embodiment of the invention, the invention allows the user to set recurring and non-recurring reminders. A recurring reminder allows the user of the invention to receive reminders on regular intervals of time, such as daily, weekly, biweekly, and monthly. A non-recurring reminder allows the user of the invention to receive one-time reminders.

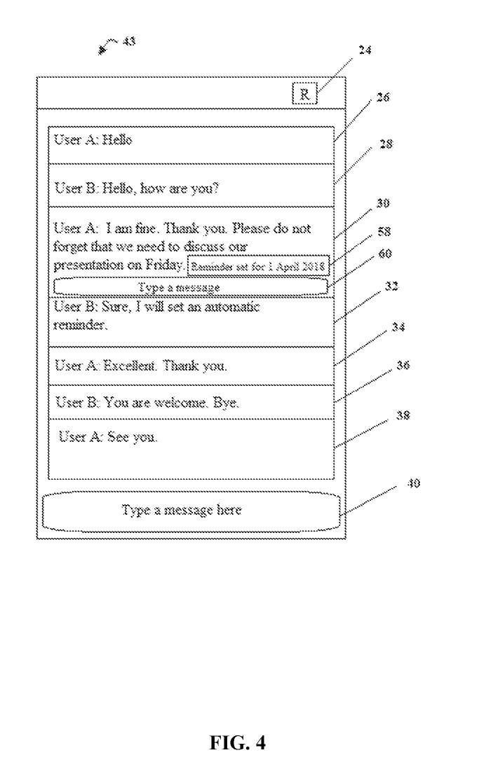

Referring now to the invention in more detail, in FIG. 4 there is an exemplary user interface of a messaging application showing a message for which a reminder is set 43. The exemplary user interface of a messaging application showing a message for which a reminder is set 43 includes a button “R” 24, an exemplary message “User A: Hello” 26, an exemplary message “User B: Hello, how are you?” 28, an exemplary message “User A: I am fine. Thank you. Please do not forget that we need to discuss our presentation on Friday.” 30, an exemplary notice “Reminder set for 1 Apr. 2018” 58, a fillable field “Type a message” 60, an exemplary message: “User B: Sure, I will send an automatic reminder.” 32, an exemplary message “User A: Excellent. Thank you.” 34, an exemplary message “User B: You are welcome. Bye.” 36, an exemplary message “User A: See you.” 38, a fillable field containing the message “Type a message here” 40.

In more detail, still referring to the invention of FIG. 4, the button “R” 24 can be used by the user of the invention to set a reminder. The exemplary message “User A: Hello” 26, the exemplary message “User B: Hello, how are you?” 28, the exemplary message “User A: I am fine. Thank you. Please do not forget that we need to discuss our presentation on Friday.” 30, the exemplary message: “User B: Sure, I will send an automatic reminder.” 32, the exemplary message “User A: Excellent. Thank you.” 34, the exemplary message “User B: You are welcome. Bye.” 36, and the exemplary message “User A: See you.” 38 constitute an exemplary chat conversation between two users of a messaging application, namely, User A and User B. The exemplary notice “Reminder set for 1 Apr. 2018” 58 and the fillable field “Type a message” 60 are added to the exemplary message “User A: I am fine. Thank you. Please do not forget that we need to discuss our presentation on Friday.” 30. The fillable field containing the message “Type a message here” 40 allows users of a messaging application to type messages.

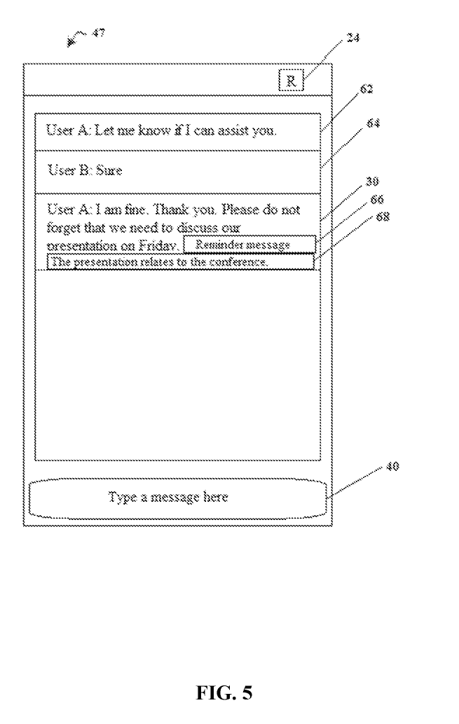

Referring now to the invention in more detail, in FIG. 5 there is an exemplary user interface of a messaging application showing a reminder 47. The exemplary user interface of a messaging application showing a reminder 47 includes the button “R” 24, the exemplary message “User A: Let me know if I can assist you” 62, the exemplary message “User B: Sure” 64, the exemplary message “User A: I am fine. Thank you. Please do not forget that we need to discuss our presentation on Friday.” 30, the exemplary notice “Reminder message” 66, the exemplary notice “The presentation relates to the conference” 68, and the fillable field containing the message “Type a message here” 40.

In more detail, still referring to the invention of FIG. 5, the exemplary message “User A: Let me know if I can assist you” 62, the exemplary message “User B: Sure” 64, and the exemplary message “User A: I am fine. Thank you. Please do not forget that we need to discuss our presentation on Friday.” 30 constitute a chat conversation between two users of a messaging application, namely, User A and User B. The exemplary notice “Reminder message” 66 and the exemplary notice “The presentation relates to the conference” 68 were added to the exemplary message “User A: I am fine. Thank you. Please do not forget that we need to discuss our presentation on Friday.” 30. The fillable field containing the message “Type a message here” 40 allows users of a messaging application to type messages. The exemplary message “User A: I am fine. Thank you. Please do not forget that we need to discuss our presentation on Friday.” 30 was automatically added to the chat conversation between two users of a messaging application, namely, User A and User B, because one of these two users has previously set a reminder by marking the exemplary message “User A: I am fine. Thank you. Please do not forget that we need to discuss our presentation on Friday.” 30 and pressing on the button “R” 24.

The advantages of the present invention include, without limitation:
The invention allows its users to set reminders including previously-exchanged text messages.
The invention allows its users to easily set reminders by marking text messages in messaging applications and pressing on a designated button.
The invention allows its users to easily access previously-exchanged text messages by clicking on the reminders including such previously-exchanged text messages.

In one embodiment of the invention, the invention is implemented in a messaging application. After being implemented in the messaging application, the invention detects whether a message is marked by the user of the messaging application. If a message is marked by the user of the messaging application, the invention detects whether the user has pressed on a designated button. If the invention detects that the user has pressed on a designated button, the invention allows the user to set time and date of a reminder. After the user sets time and date of the reminder, the user can add a text to the reminder. The reminder, including the marked message and the text added to the reminder, will appear in the user interface of the messaging application at the time and date set by the user.

The embodiment is able to be implemented, for example, using a machine-readable medium or article which is able to store an instruction or a set of instructions that, if executed by a machine, cause the machine to perform the operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software.

The machine-readable medium or article is able to include, for example, any suitable type of memory unit, memory device, memory article, memory medium, storage device, storage article, storage medium and/or storage unit; for example, memory, removable or non-removable media, erasable or non-erasable media, write-able or re-write-able media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like.

The instructions are able to include any suitable type of code, for example, source code, compiled code, interpreted code, executable code, static code, dynamic code, or the like, and are able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A method for sending reminders to users of messaging applications, the method comprising:
in a computer, detecting whether a message is marked by the user of a messaging application;
when a message is marked by the user of a messaging application, detecting whether the user presses on a designated button;
when the user presses on a designated button, requesting the user to set time and date of a reminder;
when the user sets time and date of the reminder, requesting the user to add a text to the reminder;
when the time and date set by the user comes, the reminder, including the marked message and the text added to the reminder, appears in the user interface of the messaging application.

2. The method of claim 1, wherein, when the time and date set by the user comes, the reminder, including the marked message, the text added to the reminder, and a notice “Reminder message”, appears in the user interface of the messaging application.

3. The method of claim 1, wherein the user can set recurring and non-recurring reminders.

4. The method of claim 1, wherein, when the user sets time and date of a reminder, a notice stating that a reminder has been set for a specified time and date appears under the marked message.

5. The method of claim 1, wherein, when the time and date set by the user comes, a sound signal is produced.

6. The method of claim 1, wherein, when the user presses on a designated button, a copy of the message marked by the user will immediately appear in the user interface of the messaging application.

7. The method of claim 1, wherein, when the user presses on the reminder, he or she will be immediately referred to the chat history including the marked message.
